(19) United States
(12) Patent Application Publication
(10) Pub. No.: US 2025/0132363 A1
(43) Pub. Date: Apr. 24, 2025

(54) ENHANCED REFORMING THROUGHPUT FOR MOLTEN CARBONATE FUEL CELL

(71) Applicant: EXXONMOBIL TECHNOLOGY AND ENGINEERING COMPANY, Spring, TX (US)

(72) Inventors: Anastasios I. Skoulidas, Pittstown, NJ (US); Gregory R. Johnson, Annandale, NJ (US); Clay R. Sutton, Pittstown, NJ (US); Lu Han, Ringoes, NJ (US)

(21) Appl. No.: 18/918,230

(22) Filed: Oct. 17, 2024

Related U.S. Application Data
(60) Provisional application No. 63/591,199, filed on Oct. 18, 2023.

(51) Int. Cl. H01M 8/0612; H01M 8/04014; H01M 8/04089; H01M 8/04701; H01M 8/04746; H01M 8/14

(52) U.S. Cl. CPC H01M 8/0618; H01M 8/04022; H01M 8/04097; H01M 8/04716; H01M 8/04761; H01M 8/145; H01M 2008/147

(57) ABSTRACT

Systems and methods are provided for operating molten carbonate fuel cells to produce increased amounts of H₂ in the anode effluent while still maintaining operation of the cell within conventional operation boundaries, such as having a temperature differential between the cathode input flow and the cathode effluent of 35° C. or more, with the cathode effluent being hotter than the cathode input flow. This temperature differential between the cathode input flow and the cathode effluent while still producing excess hydrogen is achieved in part by a) passing an input flow containing hydrocarbons and/or reformable fuel into an external reformer, b) reforming 20 vol % or more of the hydrocarbons and/or reformable fuel in the external reformer prior to c) passing the partially reformed input flow into a fuel cell or fuel cell stack where additional reforming is performed in the anode(s) and/or in a reforming element in the fuel cell stack.

### CROSS REFERENCE TO RELATED APPLICATIONS

This Non-Provisional patent application claims priority to U.S. Provisional Patent Application No. 63/591,199, filed Oct. 18, 2023, and titled “Enhanced Reforming Throughput For Molten Carbonate Fuel Cell”, the entire contents of which is incorporated herein by reference.

### FIELD OF THE INVENTION

Systems and methods are provided for operating a molten carbonate fuel cell to generate increased hydrogen content in the anode effluent while maintaining fuel cell operation at target temperatures and maintaining target amounts of electrical power production.

### BACKGROUND OF THE INVENTION

Molten carbonate fuel cells utilize hydrogen and/or other fuels to generate electricity. The hydrogen may be provided by reforming methane or other reformable fuels in a steam reformer, such as steam reformer located upstream of the fuel cell or integrated within the fuel cell. Fuel can also be reformed in the anode cell in a molten carbonate fuel cell, which can be operated to create conditions that are suitable for reforming fuels in the anode. Still another option can be to perform some reforming both externally and internally to the fuel cell. Reformable fuels can encompass hydrocarbonaceous materials that can be reacted with steam and/or oxygen at elevated temperature and/or pressure to produce a gaseous product that comprises hydrogen.

The basic structure of a molten carbonate fuel cell includes a cathode, an anode, and a matrix between the cathode and anode that includes one or more molten carbonate salts that serve as the electrolyte. During conventional operation of a molten carbonate fuel cell, the molten carbonate salts partially diffuse into the pores of the cathode. This diffusion of the molten carbonate salts into the pores of the cathode provides an interface region where CO₂ can be converted into CO₃²⁻ for transport across the electrolyte to the anode.

Traditionally, molten carbonate fuel cells have been operated for production of electrical power under conditions corresponding to 65% to 75% fuel utilization. This choice was made based on several factors. First, traditional operation of a fuel cell involved combusting the remaining fuel in the anode effluent to form CO₂, and then using the anode effluent as the cathode input to provide CO₂ for operation of the fuel cell. Operating at 65% to 75% fuel utilization allowed sufficient fuel to remain in the anode effluent so that sufficient CO₂ could be formed. The combustion reaction also provided heat to assist with maintaining the temperature of the fuel cell. Still another aspect of choosing this fuel utilization was that it allowed for stable generation of electrical power with regard to maintaining operating voltage and current density.

Although traditional operation of molten carbonate fuel cells focused on power generation, the nature of the operating environment for a molten carbonate fuel cell provides opportunities for other types of operation. For example, by providing a cathode input stream that is substantially independent of the content of the anode output stream, a molten carbonate fuel cell can be used as a carbon capture device. Additionally, because reforming can occur within a molten carbonate fuel cell anode, there is a potential to operate molten carbonate fuel cells under conditions where a substantial excess of hydrogen is generated in the anode output.

A journal article by Manzolini et al (Journal of Fuel Cell Science and Technology, February 2012, Vol. 9, pages 011018-1 to 011018-8) describes operation of fuel cells with cathodes connected in series for separation of CO₂ from a power plant flue gas while generating power.

U.S. Patent Application Publication 2020/0176783 describes cathode current collector structures that provide increased open area for a cathode surface adjacent to the cathode current collector.

U.S. Patent Application Publication 2011/0111315 describes systems and processes for operating fuel cells. The fuel cells are operated at low fuel utilization, with a substantial recycle of hydrogen from the anode output back to the feedstream that eventually forms the anode input. These low fuel utilization conditions, in combination with reducing or minimizing the presence of non-hydrogen components in the anode of the fuel cell, are described as allowing for an increase in the cell voltage.

U.S. Pat. No. 6,974,644 describes systems and methods for operating a fuel cell, where the amount of direct internal reforming and indirect internal reforming can be controlled to improve control over the temperature profile of the fuel cell. By definition, the direct internal reforming and indirect internal reforming both correspond to reforming that is sufficiently heat integrated with the fuel cell to impact the temperature profile of the fuel cell.

U.S. Patent Application Publication 2005/0123810 describes operation of fuel cells with lower fuel utilization so that excess hydrogen from internal reforming is available for recovery as a hydrogen gas stream.

### SUMMARY OF THE INVENTION

In an aspect, a method for operating a molten carbonate fuel cell is provided. The method includes heating an input flow containing 20 vol % or more of hydrocarbons, reformable fuel, or a combination thereof by heat exchange with at least a portion of an anode effluent. The method further includes reforming 15% or more of the hydrocarbons, reformable fuel, or a combination thereof, in the input flow to form a partially reformed input flow containing 15 vol % or more of hydrocarbons, reformable fuel, or a combination thereof, an H₂ content of 15 vol % or more, and/or 5.0 vol % or more of carbon oxides. The method further includes heating the partially reformed input flow to form an anode input flow having an anode input temperature of 550° C. or higher. The method further includes passing the anode input flow into an anode of one or more molten carbonate fuel cells, an internal reforming element associated with the anode, or a combination thereof. The method further includes passing a cathode input flow containing 4.0 vol % or more of CO₂ and a cathode input temperature of 550° C. or higher into a cathode of the one or more molten carbonate fuel cells. Additionally, the method includes operating the one or more molten carbonate fuel cells at an average current density of 100 mA/cm² or more and an operating voltage of 0.65 V to 0.75 V to form the anode effluent and a cathode effluent. The cathode effluent can have a temperature that is greater than the cathode input temperature by 35° C. or more. The anode effluent can have 18 vol % or more of H₂ and 10 vol % or less of hydrocarbons, reformable fuel, or a combination thereof.

In another aspect, the cathode effluent can instead have a temperature that is lower than the cathode input temperature. In such an aspect, the molten carbonate fuel cell can be operated at a fuel utilization of 30% or less.

### BRIEF DESCRIPTION OF THE FIGURES

FIG. 1 shows an example of a configuration for operating a molten carbonate fuel cell.

FIG. 2 shows another example of a configuration for operating a molten carbonate fuel cell.

FIG. 3 shows a general example of a portion of a molten carbonate fuel cell stack.

FIG. 4 shows a flow pattern example for a molten carbonate fuel cell with an anode flow direction that is aligned roughly perpendicular to a cathode flow direction.

### DETAILED DESCRIPTION OF THE EMBODIMENTS

### Overview

In various aspects, systems and methods are provided for operating molten carbonate fuel cells to produce increased amounts of H₂ in the anode effluent while still maintaining operation of the cell within conventional operation boundaries, such as having a temperature differential between the cathode input flow and the cathode effluent of 35° C. or more, with the cathode effluent being hotter than the cathode input flow. This temperature differential between the cathode input flow and the cathode effluent while still producing excess hydrogen is achieved in part by a) passing an input flow containing hydrocarbons and/or reformable fuel into an external reformer, b) reforming 20 vol % or more of the hydrocarbons and/or reformable fuel in the external reformer prior to c) passing the partially reformed input flow into a fuel cell or fuel cell stack where additional reforming is performed in the anode(s) and/or in a reforming element in the fuel cell stack. During such operation for production of increased amounts of H₂, the fuel cell or fuel cell stack can also be operated to maintain a voltage of 0.65 eV or more with a current density of 100 mA/cm² or more. Additionally or alternately, during such operation of increased amounts of H₂, a) 15 vol % or more of the input flow (on a wet basis) entering the anode can correspond to hydrocarbons and/or reformable fuel, b) 10 vol % or more of the input flow entering the anode can correspond to H₂, c) the hydrocarbon and/or reformable fuel content of the anode output flow can be 10 vol % or less of the anode output flow, d) the H₂ content of the anode effluent can be 18 vol % or more, or e) a combination of two or more, or three or more, of a), b), c), and d). This is an unexpected combination of operating parameters for a molten carbonate fuel cell.

The unexpected combination of operating parameters for a molten carbonate fuel cell can provide a variety of advantages. First, the system can produce excess hydrogen for use in any convenient manner while still maintaining conditions for fuel cell operation within an operating envelope that allows for extended lifetime operation of a fuel cell. Second, by performing a substantial amount of reforming in the fuel cell stack, the heat for the endothermic reforming reaction can be provided by the heat generated in the molten carbonate fuel cell. This reduces or minimizes the energy losses that are associated with performing heat exchange in an external heat exchanger. Additionally or alternately, this reduces or minimizes the amount of additional energy required for performing steam reforming in vessels outside of the fuel cell stack while still maintaining the operating conditions for extended lifetime operation in the fuel cell stack.

Conventionally, a substantial body of experience has been developed with operating molten carbonate fuel cells under traditional power generation conditions. Such conditions include an operating voltage of 0.65 to 0.75, a current density of 60 mA/cm², and a temperature differential between the anode input and the anode output of 35° C. or more. Such conditions also include providing an anode input stream to the anode where the amount of hydrocarbons and/or reformable fuel in the anode input stream corresponds to 15 vol % to 25 vol % of the stream. During such conventional operation, the fuel utilization for power generation corresponds to 65% to 75% of the total fuel (hydrogen plus reformable hydrocarbons) introduced into the anode. It is noted that in such traditional configurations, a small amount of external reforming is typically performed, so that the anode input flow has an H₂ content of 5.0 vol % to 10 vol %. This H₂ content facilitates performing the reforming reaction in the anode. Due to this large body of experience, it is known that molten carbonate fuel cells can be operated for extended periods under these conditions. It would be desirable to use the fuel cell to generate additional hydrogen while still operating the fuel cell within this known window of stable operation.

Unfortunately, there are several difficulties with attempting to maintain conventional operation while generating additional hydrogen. First, performing additional internal reforming will result in modification of the temperature profile of the fuel cell. Because reforming is an endothermic reaction, changing the amount of reforming within the fuel cell will modify the temperature profile. Increasing the amount of reforming will result in cooling of the output flows from the fuel cell, while decreasing the amount of reforming will result in heating of the output flows. Thus, simply performing an increased amount of reforming within the fuel cell to increase hydrogen production will result in temperature profile where the temperature differential between cathode input and cathode output is less than 35° C. Potentially, if enough internal reforming occurs, the temperature of the anode output could actually be lower than the temperature of the anode input.

An alternative to internal reforming is to use external reforming. However, conventional uses of external reforming are typically designed to reduce or minimize the amount of reformable fuel that is delivered to a fuel cell. In such conventional systems, the amount of reformable hydrocarbons delivered to the anode is reduced or minimized.

As an example of conventional operating conditions, a typical feed to the anode input of a molten carbonate fuel cell or to an external reformer located upstream from the anode input of the fuel cell is a feed containing roughly 15 vol % to 25 vol % of a reformable hydrocarbon fuel (such as methane) and 5.0 vol % to 10 vol % of a H₂. The input flow to the anode or the external reformer typically contains 1.0 vol % or less of CO and 1.0 vol % or less of CO₂. In conventional systems where an external reformer is used, the flow into the anode input is modified due to at least partial reforming of the hydrocarbons in the input flow to the external reformer. However, the increase in CO and/or CO₂ into the anode input is offset by a decrease in the amount of reformable hydrocarbon that is passed into the anode input. Regardless of whether an external reformer is used or not, a conventional output flow from the anode corresponds to utilization of roughly 65% to 75% of the fuel passed into the molten carbonate fuel cell. Due to this high fuel utilization, the hydrogen content of a conventional anode effluent is 10 vol % or less. The fuel cell is operated with a temperature differential between the cathode inlet and cathode outlet (i.e., difference in temperature between cathode input flow and cathode effluent) of 35° C. or more.

By contrast, in various aspects, systems and methods are provided where the hydrocarbon content (such as methane) of the flow out of the external reformer and/or into the anode corresponds to 15 vol % or more of the flow, or 20 vol % or more, such as up to 30 vol % or possibly still higher, while also having a substantial presence of CO and/or CO₂ in the flow into the anode. The presence of the carbon oxides is due to the fact that substantial reforming has already been performed, even though additional substantial performing will be performed within the fuel cell stack. In some aspects, the output from the external reformer and/or the input flow to the anode can contain 5.0 vol % or more of CO₂, or 7.5 vol % or more, or 9.0 vol % or more, such as up 15 vol % or possibly still higher. Additionally or alternately, the input flow to the anode can contain 5.0 vol % or more of carbon oxides (CO plus CO₂), or 8.0 vol % or more, such as up to 15 vol % or possibly still higher. Further additionally or alternately, the input flow to the anode can contain 0.5 vol % or more of CO, or 1.5 vol % or more, or 2.5 vol % or more, such as up to 5.0 vol % or possibly still higher. Still further additionally or alternately, the hydrogen (H₂) content of the anode input stream can be 10 vol % to 35 vol %, or 10 vol % to 30 vol %, or 10 vol % to 25 vol %. Yet further additionally or alternately, the hydrogen (H₂) content of the anode effluent is 10 vol % or more, or 15 vol % or more, or 18 vol % or more, or 20 vol % or more, or 25 vol % or more, such as up to 45 vol % or possibly still higher.

The input flow into the external reformer can also be different from a conventional system when viewed in combination with the output flow exiting from the anode. In various aspects, the volume percentage of hydrocarbons in the input flow to the external reforming stage can be greater than the volume percentage of hydrocarbons in the anode effluent by 30 vol % or more, or 35 vol % or more, or 40 vol % or more, such as up to 60 vol % or possibly still higher. As an example, if the input flow to the external reforming stage has a hydrocarbon content of 45 vol % (relative to the volume of the input flow to the external reforming stage) and the anode effluent has a hydrocarbon content of 5.0 vol % (relative to the volume of the anode effluent flow), the difference between the input flow to the external reforming stage and the anode effluent is 40 vol %. In such aspects, the temperature differential between the cathode input and the cathode output can be 35° C. or more, or 45° C. or more, or 50° C. or more, such as up to 100° C. or possibly still higher. Additionally or alternately, the hydrogen content of the anode effluent can be 20 vol % or more, or 30 vol % or more, or 35 vol % or more, such as up to 55 vol % or possibly still higher.

Various combinations of the above conditions can allow a molten carbonate fuel cell to be operated with a “conventional” temperature differential of 35° C. or more (or 45° C. or more, or 50° C. or more) between the cathode inlet and cathode outlet while still generating electrical power and producing an anode effluent with an increased content of hydrogen. This allows a fuel cell to operate with extended lifetime while also producing excess hydrogen. In order to achieve this, substantial amounts of both external reforming and internal reforming can be performed. Relative to the hydrocarbon content (and/or other reformable fuel) in the input flow to the external reformer, the amount of reforming in the external reformer can correspond to reforming of 20 vol % or more of the hydrocarbon content (and/or reformable fuel), or 25 vol % or more, or 30 vol % or more, such as up to 60 vol % or possibly still higher. Additionally, relative to the hydrocarbon content (and/or reformable fuel) in the input flow to the external reformer, the amount of reforming that occurs internal to a molten carbonate fuel cell stack (directly in the anode and/or indirectly in a stack element that performs reforming) can correspond to reforming of 10 vol % or more of the hydrocarbon content (and/or reformable fuel), or 15 vol % or more, or 20 vol % or more, such as up to 40 vol % or possibly still higher. In such aspects, the fuel utilization (U_{f}) for the fuel cell relative to the input flow entering the external reformer can be 55% or less, or 45% or less, or 35% or less, such as down to 15% or possibly still lower.

It is noted that volume percentages of gas flows can be reported either on a “wet” basis, where all components in the gas flow are used to calculate volume percentages, or on a “dry” basis, where any water present in the gas flow is not considered when calculating volume percentages. In this discussion, unless otherwise specified, all volume percentages for gas flows are on a “wet” basis. It is understood that for a gas flow with no water content, the “wet” basis and “dry” basis values are identical.

External Reforming with Heat Integration

When operating a molten carbonate fuel cell to have a temperature differential of 35° C. or more between the cathode inlet and cathode outlet while also producing excess hydrogen, additional benefits can be achieved by providing heat integration between the output flows of the fuel cell and the external reformer. This heat integration can allow a portion of the heat from the anode exhaust to be used as heat for performing the external reforming. Additional heat integration can allow the burner used for heating of the cathode input flow to be used for heating of the output from the external reforming stage and/or anode input flow.

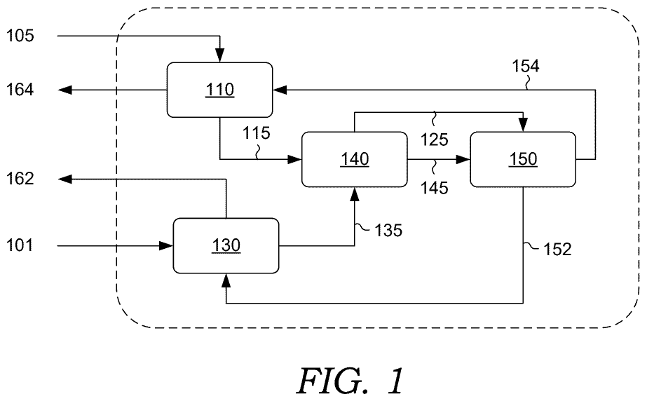

FIG. 1 shows an example of a configuration for providing heat integration between the anode effluent and the external reformer. In the configuration shown in FIG. 1, molten carbonate fuel cell stack 150 receives cathode input flow 145 and anode input flow 125. It is noted that cathode input flow 145 and/or anode input flow 125 can represent any desired number of separate or individual flows that are passed into one or more cathodes and/or one or more anodes of fuel cell stack 150.

In the configuration shown in FIG. 1, cathode input flow 145 is generated by heating a CO₂-containing stream 105 in a heat exchanger 110. The heat exchanger 110 allows for heat exchange between CO₂-containing stream 105 and cathode effluent 154. This type of heat exchanger can also be referred to as a cathode recuperator. The heat exchanger 110 produces a partially heated CO₂-containing stream 115 and a cooled cathode effluent 164. The partially heated CO₂-containing stream 115 is then passed into a heater or burner 140. The heater or burner 140 heats the partially heated CO₂-containing stream 115 to form the cathode input flow 145. It is noted that O₂ can be present in CO₂-containing stream 105, or O₂ can be added at any convenient location prior to when cathode input flow 145 enters the cathode(s) of molten carbonate fuel cell stack 150.

In the configuration shown in FIG. 1, anode input flow 125 is generated by heating a fuel stream 101 in a heat exchanger 130. The heat exchanger 130 allows for heat exchange between fuel stream 101 and anode effluent 152. This type of heat exchanger can also be referred to as an anode effluent recuperator 130. The heat exchanger 130 produces a partially heated fuel stream 135 and a cooled anode effluent 162. The partially heated fuel stream 135 is then passed into heater or burner 140 along a separate flow path. This forms anode input flow 125.

The external reforming can occur in one or both of heat exchanger 130 (i.e., anode effluent recuperator) and the separate flow path in heater 140. If the external reforming occurs in heat exchanger 130, the reforming catalyst is located on the “cold” side of the heat exchanger 130. Performing the external reforming in the heat exchanger 130 allows the heat from the anode effluent to be used to provide the heat for the endothermic reforming reaction. If larger amounts of reforming are desired, external reforming can be performed at least in part in the heater 140, so that the heater duty can be adjusted to maintain a target temperature for the anode input flow 125 while also performing a desired amount of reforming.

### Definitions

Reformable Fuel: Reformable fuel is defined as any compound that contains sufficient amounts of hydrogen atoms and carbon atoms so that the compound can be at least partially converted in H₂ and carbon oxides under conditions suitable for hydrocarbon reforming. Alcohols are an example of non-hydrocarbon compounds that can also be reformed to produce at least H₂ and carbon oxides.

Fuel cell and fuel cell stack definitions: In this discussion, a fuel cell can correspond to a single cell, with an anode and a cathode separated by an electrolyte. The anode and cathode can receive input gas flows to facilitate the respective anode and cathode reactions for transporting charge across the electrolyte and generating electricity. A fuel cell stack can represent a plurality of cells in an integrated unit. Although a fuel cell stack can include multiple fuel cells, the fuel cells can typically be connected in parallel and can function (approximately) as if they collectively represented a single fuel cell of a larger size. When an input flow is delivered to the anode or cathode of a fuel cell stack, the fuel stack can include flow channels for dividing the input flow between each of the cells in the stack and flow channels for combining the output flows from the individual cells. In this discussion, a fuel cell array can be used to refer to a plurality of fuel cells (such as a plurality of fuel cell stacks) that are arranged in series, in parallel, or in any other convenient manner (e.g., in a combination of series and parallel). A fuel cell array can include one or more stages of fuel cells and/or fuel cell stacks, where the anode/cathode output from a first stage may serve as the anode/cathode input for a second stage. It is noted that the anodes in a fuel cell array do not have to be connected in the same way as the cathodes in the array. For convenience, the input to the first anode stage of a fuel cell array may be referred to as the anode input for the array, and the input to the first cathode stage of the fuel cell array may be referred to as the cathode input to the array. Similarly, the output from the final anode/cathode stage may be referred to as the anode/cathode output from the array.

It should be understood that reference to use of a fuel cell herein typically denotes a “fuel cell stack” composed of individual fuel cells, and more generally refers to use of one or more fuel cell stacks in fluid communication. Individual fuel cell elements (plates) can typically be “stacked” together in a rectangular array called a “fuel cell stack”. This fuel cell stack can typically take a feed stream and distribute reactants among all of the individual fuel cell elements and can then collect the products from each of these elements. When viewed as a unit, the fuel cell stack in operation can be taken as a whole even though composed of many (often tens or hundreds) of individual fuel cell elements. These individual fuel cell elements can typically have similar voltages (as the reactant and product concentrations are similar), and the total power output can result from the summation of all of the electrical currents in all of the cell elements, when the elements are electrically connected in series. Stacks can also be arranged in a series arrangement to produce high voltages. A parallel arrangement can boost the current. If a sufficiently large volume fuel cell stack is available to process a given exhaust flow, the systems and methods described herein can be used with a single molten carbonate fuel cell stack. In other aspects of the invention, a plurality of fuel cell stacks may be desirable or needed for a variety of reasons.

For the purposes of this invention, unless otherwise specified, the term “fuel cell” should be understood to also refer to and/or is defined as including a reference to a fuel cell stack composed of set of one or more individual fuel cell elements for which there is a single input and output, as that is the manner in which fuel cells are typically employed in practice. Similarly, the term fuel cells (plural), unless otherwise specified, should be understood to also refer to and/or is defined as including a plurality of separate fuel cell stacks. In other words, all references within this document, unless specifically noted, can refer interchangeably to the operation of a fuel cell stack as a “fuel cell”. For example, the volume of exhaust generated by a commercial scale combustion generator may be too large for processing by a fuel cell (i.e., a single stack) of conventional size. In order to process the full exhaust, a plurality of fuel cells (i.e., two or more separate fuel cells or fuel cell stacks) can be arranged in parallel, so that each fuel cell can process (roughly) an equal portion of the combustion exhaust. Although multiple fuel cells can be used, each fuel cell can typically be operated in a generally similar manner, given its (roughly) equal portion of the combustion exhaust.

### Molten Carbonate Fuel Cell Structure

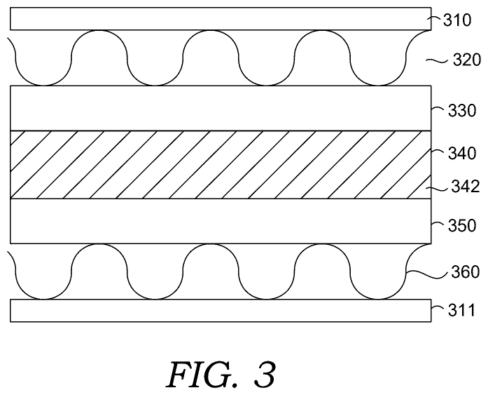

FIG. 3 shows a general example of a portion of a molten carbonate fuel cell stack which substantially corresponds to a single fuel cell. The portion of the stack shown in FIG. 3 corresponds to a fuel cell 301. In order to isolate the fuel cell from adjacent fuel cells in the stack and/or other elements in the stack, the fuel cell includes separator plates 310 and 311. In FIG. 3, the fuel cell 301 includes an anode 330 and a cathode 350 that are separated by an electrolyte matrix 340 that contains an electrolyte 342. In various aspects, cathode 350 can correspond to a dual-layer (or multi-layer) cathode. Anode collector 320 provides electrical contact between anode 330 and the other anodes in the stack, while cathode current collector 360 provides similar electrical contact between cathode 350 (via the structural mesh layer) and the other cathodes in the fuel cell stack. Additionally anode collector 320 allows for introduction and exhaust of gases from anode 330, while cathode current collector 360 allows for introduction and exhaust of gases from cathode 350. In some aspects, a structural mesh layer (not shown) can be disposed between cathode 350 and cathode current collector 360.

During operation, CO₂ is passed into the cathode current collector 360 along with O₂. The CO₂ and O₂ diffuse into the porous cathode 350 and travel to a cathode interface region near the boundary of cathode 350 and electrolyte matrix 340. In the cathode interface region, a portion of electrolyte 342 can be present in the pores of cathode 350. The CO₂ and O₂ can be converted near/in the cathode interface region to carbonate ion (CO₃²⁻), which can then be transported across electrolyte 342 (and therefore across electrolyte matrix 340) to facilitate generation of electrical current. After transport across the electrolyte 342, the carbonate ion can reach an anode interface region near the boundary of electrolyte matrix 340 and anode 330. The carbonate ion can be converted back to CO₂ and H₂O in the presence of H₂, releasing electrons that are used to form the current generated by the fuel cell. The H₂ and/or a hydrocarbon suitable for forming H₂ are introduced into anode 330 via anode collector 320.

### Example of Molten Carbonate Fuel Cell Operation: Cross Flow Orientation for Cathode and Anode

The flow direction within the anode of a molten carbonate fuel cell can have any convenient orientation relative to the flow direction within a cathode. One option can be to use a co-current or counter-current flow configuration. Using co-current flow or counter-current flow can assist with providing higher uniformity in gas concentrations within a fuel cell. However, using co-current or counter-current flow can increase the complexity of the gas flow management. U.S. Patent Application Publication 2021/0159523 describes examples of how to manage the flows to a fuel cell when operated in co-current or counter-current mode.

Another option can be to use a cross-flow configuration, so that the flow direction within the anode is roughly at a 90° angle relative to the flow direction within the cathode. This type of flow configuration can have practical benefits, as using a cross-flow configuration can allow the manifolds and/or piping for the anode inlets/outlets to be located on different sides of a fuel cell stack from the manifolds and/or piping for the cathode inlets/outlets.

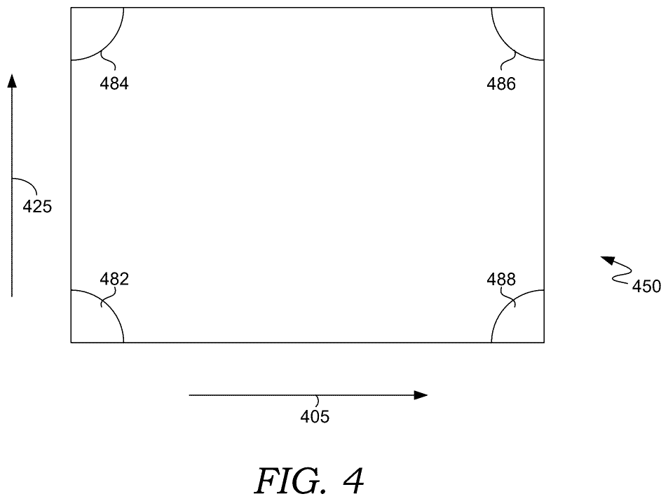

FIG. 4 schematically shows an example of a top view for a fuel cell cathode, along with arrows indicating the direction of flow within the fuel cell cathode and the corresponding fuel cell anode. In FIG. 4, arrow 405 indicates the direction of flow within cathode 450, while arrow 425 indicates the direction of flow with the anode (not shown).

Because the anode and cathode flows are oriented at roughly 90° relative to each other, the anode and cathode flow patterns can contribute to having different reaction conditions in various parts of the cathode. Corner 482 corresponds to a portion of the fuel cell that is close to the entry point for both the cathode input flow and the anode input flow. As a result, the concentration of both CO₂ (in the cathode) and H₂ (in the anode) can be relatively high in corner 482, depending on the fuel utilization and the CO₂ utilization. Corner 484 corresponds to a portion of the fuel cell that is close to the entry point for the cathode input flow and close to the exit point for the anode output flow. In locations near corner 484, the concentration of H₂ (in the anode) may be reduced under some conditions, while the CO₂ concentration may be relatively higher. Corner 486 corresponds to a portion of the fuel cell that is close to the exit point for the anode output flow and close to the exit point for the cathode output flow. In locations near corner 486, the concentrations of both H₂ (in the anode) and CO₂ (in the cathode) can potentially be lower, depending on the operating conditions for the fuel cell. Corner 488 corresponds to a portion of the fuel cell that is close to the entry point for the anode input flow and close to the exit point for the cathode output flow. In locations near corner 484, the concentration of H₂ (in the anode) may be increased under some conditions, while the CO₂ concentration may be relatively lower.

### Anode Inputs and Outputs

In various aspects, the anode input stream and/or the input stream to an external reformer associated with an MCFC can include hydrogen, a hydrocarbon such as methane, a hydrocarbonaceous or hydrocarbon-like compound that may contain heteroatoms different from C and H, or a combination thereof. The source of the hydrogen/hydrocarbon/hydrocarbon-like compounds can be referred to as a fuel source. In some aspects, most of the methane (or other hydrocarbon, hydrocarbonaceous, or hydrocarbon-like compound) fed to the anode and/or fed to an external reformer can typically be fresh methane. In this description, a fresh fuel such as fresh methane refers to a fuel that is not recycled from another fuel cell process. For example, methane recycled from the anode outlet stream back to the anode inlet may not be considered “fresh” methane, and can instead be described as reclaimed methane.

The fuel source used can be shared with other components, such as a turbine that uses a portion of the fuel source to provide a CO₂-containing stream for the cathode input. The fuel source input can include water in a proportion to the fuel appropriate for reforming the hydrocarbon (or hydrocarbon-like) compound in the reforming section that generates hydrogen. For example, if methane is the fuel input for reforming to generate H₂, the molar ratio of water to fuel can be from about one to one to about ten to one, such as at least about two to one. A ratio of four to one or greater is typical for external reforming, but lower values can be typical for internal reforming. To the degree that H₂ is a portion of the fuel source, in some optional aspects no additional water may be needed in the fuel, as the oxidation of H₂ at the anode can tend to produce H₂O that can be used for reforming the fuel. The fuel source can also optionally contain components incidental to the fuel source (e.g., a natural gas feed can contain some content of CO₂ as an additional component). For example, a natural gas feed can contain CO₂, N₂, and/or other inert (noble) gases as additional components. Optionally, in some aspects the fuel source may also contain CO, such as CO from a recycled portion of the anode exhaust. An additional or alternate potential source for CO in the fuel into a fuel cell assembly can be CO generated by steam reforming of a hydrocarbon fuel performed on the fuel prior to entering the fuel cell assembly.

More generally, a variety of types of fuel streams may be suitable for use as an anode input stream and/or the input stream for an external reformer associated with a molten carbonate fuel cell. Some fuel streams can correspond to streams containing hydrocarbons and/or hydrocarbon-like compounds that may also include heteroatoms different from C and H. Examples of hydrocarbon (including hydrocarbon-like) fuel streams include natural gas, streams containing C1-C4 carbon compounds (such as methane or ethane), and streams containing heavier C5+ hydrocarbons (including hydrocarbon-like compounds), as well as combinations thereof. Still other additional or alternate examples of potential fuel streams for use in an anode input can include biogas-type streams, such as methane produced from natural (biological) decomposition of organic material.

In some aspects, a molten carbonate fuel cell can be used to process an input fuel stream, such as a natural gas and/or hydrocarbon stream, with a low energy content due to the presence of diluent compounds. For example, some sources of methane and/or natural gas are sources that can include substantial amounts of either CO₂ or other inert molecules, such as nitrogen, argon, or helium. Due to the presence of elevated amounts of CO₂ and/or inerts, the energy content of a fuel stream based on the source can be reduced. Using a low energy content fuel for a combustion reaction (such as for powering a combustion-powered turbine) can pose difficulties. However, a molten carbonate fuel cell can generate power based on a low energy content fuel source with a reduced or minimal impact on the efficiency of the fuel cell. The presence of additional gas volume can require additional heat for raising the temperature of the fuel to the temperature for reforming and/or the anode reaction. Additionally, due to the equilibrium nature of the water gas shift reaction within a fuel cell anode, the presence of additional CO₂ can have an impact on the relative amounts of H₂ and CO present in the anode output. However, the inert compounds otherwise can have only a minimal direct impact on the reforming and anode reactions. The amount of CO₂ and/or inert compounds in a fuel stream for a molten carbonate fuel cell, when present, can be at least about 1 vol %, such as at least about 2 vol %, or at least about 5 vol %, or at least about 10 vol %, or at least about 15 vol %, or at least about 20 vol %, or at least about 25 vol %, or at least about 30 vol %, or at least about 35 vol %, or at least about 40 vol %, or at least about 45 vol %, or at least about 50 vol %, or at least about 75 vol %. Additionally or alternately, the amount of CO₂ and/or inert compounds in a fuel stream for a molten carbonate fuel cell can be about 90 vol % or less, such as about 75 vol % or less, or about 60 vol % or less, or about 50 vol % or less, or about 40 vol % or less, or about 35 vol % or less.

Yet other examples of potential sources for an anode input stream and/or input stream for an external reformer can correspond to refinery and/or other industrial process output streams. For example, coking is a common process in many refineries for converting heavier compounds to lower boiling ranges. Coking typically produces an off-gas containing a variety of compounds that are gases at room temperature, including CO and various C₁-C₄ hydrocarbons. This off-gas can be used as at least a portion of an anode input stream. Other refinery off-gas streams can additionally or alternately be suitable for inclusion in an anode input stream, such as light ends (C₁-C₄) generated during cracking or other refinery processes. Still other suitable refinery streams can additionally or alternately include refinery streams containing CO or CO₂ that also contain H₂ and/or reformable fuel compounds.

Still other potential sources for an anode input and/or input for an external reformer can additionally or alternately include streams with increased water content. For example, an ethanol output stream from an ethanol plant (or another type of fermentation process) can include a substantial portion of H₂O prior to final distillation. Such H₂O can typically cause only minimal impact on the operation of a fuel cell. Thus, a fermentation mixture of alcohol (or other fermentation product) and water can be used as at least a portion of an anode input stream.

Biogas, or digester gas, is another additional or alternate potential source for an anode input and/or external reformer input. Biogas may primarily comprise methane and CO₂ and is typically produced by the breakdown or digestion of organic matter. Anaerobic bacteria may be used to digest the organic matter and produce the biogas. Impurities, such as sulfur-containing compounds, may be removed from the biogas prior to use as an anode input.

The output stream from an MCFC anode can include H₂O, CO₂, CO, and H₂. Optionally, the anode output stream could also have unreacted fuel (such as H₂ or CH₄) or inert compounds in the feed as additional output components. Instead of using this output stream as a fuel source to provide heat for a reforming reaction or as a combustion fuel for heating the cell, one or more separations can be performed on the anode output stream to separate the CO₂ from the components with potential value as inputs to another process, such as H₂ or CO. The H₂ and/or CO can be used as a syngas for chemical synthesis, as a source of hydrogen for chemical reaction, and/or as a fuel with reduced greenhouse gas emissions.

### Cathode Inputs and Outputs

Conventionally, a molten carbonate fuel cell can be operated based on drawing a desired load while consuming some portion of the fuel in the fuel stream delivered to the anode. The voltage of the fuel cell can then be determined by the load, fuel input to the anode, air and CO₂ provided to the cathode, and the internal resistances of the fuel cell. The CO₂ to the cathode can be conventionally provided in part by using the anode exhaust as at least a part of the cathode input stream. By contrast, the present invention can use separate/different sources for the anode input and cathode input. By removing any direct link between the composition of the anode input flow and the cathode input flow, additional options become available for operating the fuel cell, such as to generate excess synthesis gas, to improve capture of carbon dioxide, and/or to improve the total efficiency (electrical plus chemical power) of the fuel cell, among others.

One example of a suitable CO₂-containing stream for use as a cathode input flow can be an output or exhaust flow from a combustion source. Examples of combustion sources include, but are not limited to, sources based on combustion of natural gas, combustion of coal, and/or combustion of other hydrocarbon-type fuels (including biologically derived fuels). Additional or alternate sources can include other types of boilers, fired heaters, furnaces, and/or other types of devices that burn carbon-containing fuels in order to heat another substance (such as water or air). Depending on the aspect, the CO₂ utilization in the fuel cell can be 50% or more, or 70% or more, or 80% or more, or 90% or more, such as up to 98% or possibly still higher. It is noted that molten carbonate fuel cells used in conventional configurations for power generation typically operate with a CO₂ utilization below 70%. By contrast, the benefits of including a structural mesh layer can also be realized when using a fuel cell to perform other applications, such as using a fuel cell to achieve a target level of carbon capture. In such aspects, the CO₂ utilization can be 70% to 98%, or 75% to 98%, or 80% to 98%. In some aspects, the CO₂ content of the cathode input stream can be 3.0 vol % to 20 vol %, or 3.0 vol % to 15 vol %, or 5.0 vol % to 20 vol %, or 5.0 vol % to 15 vol %, or 10 vol % to 20 vol %. In other aspects, such as some aspects where the cathode input stream is based on a flue gas from a natural gas-fired power plant, the CO₂ content of the cathode input stream can be 5.0 vol % or less, or 4.0 vol % or less, such as 1.5 vol % to 5.0 vol %, or 1.5 vol % to 4.0 vol %, or 2.0 vol % to 5.0 vol %, or 2.0 vol % to 4.0 vol %. In some aspects, the CO₂ content of the cathode output stream can be 1.5 vol % or less, or 1.0 vol % or less, such as down to 0.1 vol % or possibly still lower.

Other potential sources for a cathode input stream can additionally or alternately include sources of bio-produced CO₂. This can include, for example, CO₂ generated during processing of bio-derived compounds, such as CO₂ generated during ethanol production. An additional or alternate example can include CO₂ generated by combustion of a bio-produced fuel, such as combustion of lignocellulose. Still other additional or alternate potential CO₂ sources can correspond to output or exhaust streams from various industrial processes, such as CO₂-containing streams generated by plants for manufacture of steel, cement, and/or paper.

Yet another additional or alternate potential source of CO₂ can be CO₂-containing streams from a fuel cell. The CO₂-containing stream from a fuel cell can correspond to a cathode output stream from a different fuel cell, an anode output stream from a different fuel cell, a recycle stream from the cathode output to the cathode input of a fuel cell, and/or a recycle stream from an anode output to a cathode input of a fuel cell. For example, an MCFC operated in standalone mode under conventional conditions can generate a cathode exhaust with a CO₂ concentration of at least about 5 vol %. Such a CO₂-containing cathode exhaust could be used as a cathode input for an MCFC operated according to an aspect of the invention. More generally, other types of fuel cells that generate a CO₂ output from the cathode exhaust can additionally or alternately be used, as well as other types of CO₂-containing streams not generated by a “combustion” reaction and/or by a combustion-powered generator. Optionally but preferably, a CO₂-containing stream from another fuel cell can be from another molten carbonate fuel cell. For example, for molten carbonate fuel cells connected in series with respect to the cathodes, the output from the cathode for a first molten carbonate fuel cell can be used as the input to the cathode for a second molten carbonate fuel cell.

In addition to CO₂, a cathode input stream can include O₂ to provide the components necessary for the cathode reaction. Some cathode input streams can be based on having air as a component. For example, a combustion exhaust stream can be formed by combusting a hydrocarbon fuel in the presence of air. Such a combustion exhaust stream, or another type of cathode input stream having an oxygen content based on inclusion of air, can have an oxygen content of about 20 vol % or less, such as about 15 vol % or less, or about 10 vol % or less. Additionally or alternately, the oxygen content of the cathode input stream can be at least about 4 vol %, such as at least about 6 vol %, or at least about 8 vol %. More generally, a cathode input stream can have a suitable content of oxygen for performing the cathode reaction. In some aspects, this can correspond to an oxygen content of about 5 vol % to about 15 vol %, such as from about 7 vol % to about 9 vol %. For many types of cathode input streams, the combined amount of CO₂ and O₂ can correspond to less than about 21 vol % of the input stream, such as less than about 15 vol % of the stream or less than about 10 vol % of the stream. An air stream containing oxygen can be combined with a CO₂ source that has low oxygen content. For example, the exhaust stream generated by burning coal may include a low oxygen content that can be mixed with air to form a cathode inlet stream.

In addition to CO₂ and O₂, a cathode input stream can also be composed of inert/non-reactive species such as N₂, H₂O, and other typical oxidant (air) components. For example, for a cathode input derived from an exhaust from a combustion reaction, if air is used as part of the oxidant source for the combustion reaction, the exhaust gas can include typical components of air such as N₂, H₂O, and other compounds in minor amounts that are present in air. Depending on the nature of the fuel source for the combustion reaction, additional species present after combustion based on the fuel source may include one or more of H₂O, oxides of nitrogen (NOx) and/or sulfur (SOx), and other compounds either present in the fuel and/or that are partial or complete combustion products of compounds present in the fuel, such as CO. These species may be present in amounts that do not poison the cathode catalyst surfaces though they may reduce the overall cathode activity. Such reductions in performance may be acceptable, or species that interact with the cathode catalyst may be reduced to acceptable levels by known pollutant removal technologies.

The amount of O₂ present in a cathode input stream (such as an input cathode stream based on a combustion exhaust) can advantageously be sufficient to provide the oxygen needed for the cathode reaction in the fuel cell. Thus, the volume percentage of O₂ can advantageously be at least 0.5 times the amount of CO₂ in the exhaust. Optionally, as necessary, additional air can be added to the cathode input to provide sufficient oxidant for the cathode reaction. When some form of air is used as the oxidant, the amount of N₂ in the cathode exhaust can be at least about 78 vol %, e.g., at least about 88 vol %, and/or about 95 vol % or less. In some aspects, the cathode input stream can additionally or alternately contain compounds that are generally viewed as contaminants, such as H₂S or NH₃. In other aspects, the cathode input stream can be cleaned to reduce or minimize the content of such contaminants.

A suitable temperature for operation of an MCFC can be between about 450° C. and about 750° C., such as at least about 500° C., e.g., with a cathode inlet temperature of about 550° C. and a cathode outlet temperature of about 625° C. Prior to entering the cathode, heat can be added to or removed from the cathode input stream, if desired, e.g., to provide heat for other processes, such as reforming the fuel input for the anode. For example, if the source for the cathode input stream is a combustion exhaust stream, the combustion exhaust stream may have a temperature greater than a desired temperature for the cathode inlet. In such an aspect, heat can be removed from the combustion exhaust prior to use as the cathode input stream. Alternatively, the combustion exhaust could be at very low temperature, for example after a wet gas scrubber on a coal-fired boiler, in which case the combustion exhaust can be below about 100° C. Alternatively, the combustion exhaust could be from the exhaust of a gas turbine operated in combined cycle mode, in which the gas can be cooled by raising steam to run a steam turbine for additional power generation. In this case, the gas can be below about 50° C. Heat can be added to a combustion exhaust that is cooler than desired.

### EXAMPLES

The following examples correspond to equilibrium steady state results determined by modeling.

### Comparative Example 1—MCFC Operation with Low Fuel Utilization and Low Temperature Differential

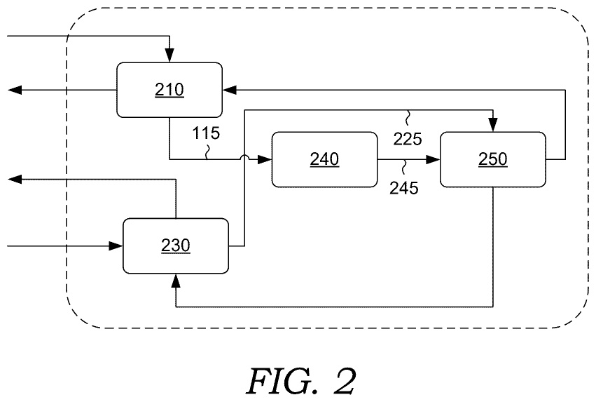

FIG. 2 shows an example of a configuration for a fuel cell stack 250 that does not include an external reformer. In the configuration shown in FIG. 2, substantially all reforming occurs in the anodes of the fuel cell stack and/or in reforming elements incorporated into the fuel cell stack 250. In the configuration shown in FIG. 2, the anode input flow 225 is pre-heated in part by heat exchange in anode effluent recuperator 230. The anode input flow is provided to the anode at a temperature of 610° C. The cathode input flow 245 is pre-heated in cathode recuperator 210, followed by heating in burner 240. This results in a cathode input flow with a temperature of 610° C.

In this example, the fuel for the anode is initially in the form of only methane. Although not shown, a limited amount of reforming corresponding to 10% of the fuel in the anode input flow is performed. This provides sufficient hydrogen so that the reforming reaction proceeds efficiently in the anode. Another 70% of the fuel is reformed in the anode to form hydrogen. (Due to equilibrium considerations, the remaining 20% of the fuel is unreformed and is exhausted as part of the anode effluent.) However, the fuel utilization is only 35%. Due to the excess amount of internal reforming relative to the fuel utilization, the temperature of the cathode effluent (580° C.) is actually lower than the cathode input temperature (610° C.). The anode effluent is similarly at 580° C., a lower temperature than the 610° C. of the anode input flow.

### Example 2—Additional Hydrogen Generation with Target Fuel Cell Stack Temperature Differential

This example is based on a configuration similar to the configuration shown in FIG. 1. In this example, external reforming is performed in the cold side of the anode effluent recuperator. Because the anode effluent recuperator contains reforming catalyst, only a limited amount of net heating of the input flow occurs in the recuperator. The anode effluent passing through the anode effluent recuperator enters at a temperature of 630° C. and exits at a temperature of 320° C. However, because reforming is performed in the recuperator, in this example, the input flow to the recuperator (and external reformer) has a temperature of 245° C., while the exit flow is only at a temperature of 354° C. The remaining heat from the anode effluent is consumed by the endothermic reforming reaction. This increases the amount of external reforming from the 10% in Comparative Example 1 to 28% in this example. Due to the low temperature of the partially reformed flow exiting from the recuperator, the partially reformed flow is then passed into the burner to raise the temperature of the partially reformed flow to a temperature of 570° C. for use as the anode input flow. Additional reforming is performed in the fuel cell stack, but because part of the input flow has already been reformed, the differential between the cathode inlet (570° C.) and cathode outlet (630° C.) for the fuel cell stack is maintained at 60° C.

In this example, the composition of the flow exiting from the recuperator/external reformer is 20 vol % CH₄, 8 vol % carbon oxides (CO plus CO₂), 23 vol % H₂, and 48 vol % H₂O. This flow is then passed into the fuel cell stack. Because reforming is an equilibrium process, not all of the CH₄ is reformed. The resulting anode effluent flow contains 5 vol % of CH₄.

In this example, the fuel utilization relative to the total fuel in the anode input flow is roughly 55%. However, because of the reforming that occurred in the recuperator, the amount of reforming in the fuel cell stack is balanced relative to the amount of fuel utilization, so that the temperature differential between cathode inlet and cathode outlet is 60° C. If all of the reforming were instead performed in the fuel cell stack, the temperature differential between cathode inlet and cathode outlet would be less than 35° C.

### Example 3—External Reforming Plus Low Fuel Utilization

In some alternative aspects, performing substantial external reforming can be combine with performing excess reforming in the fuel cell stack to provide still further hydrogen production in the anode effluent. In this type of example, the configuration shown in FIG. 1 can be used again, but this time the amount of fuel reformed in the fuel cell stack is in substantial excess relative to conventional operation. As a result, the temperature of the cathode effluent is colder than the cathode input flow.

In this example, the initial flow into the recuperator has the same composition as Example 2, but the flow rate is increased by 50%. Similar to Example 2, 28 vol % of the hydrocarbons in the initial flow into the recuperator are reformed, with the remaining reforming taking place in the fuel cell. The fuel cell is operated to generate the same amount of power as in Example 2. Thus, due to the higher flow rate of fuel, the fuel utilization is reduced to 35%.

### ADDITIONAL EMBODIMENTS

Embodiment 1. A method for operating a molten carbonate fuel cell, comprising: heating an input flow comprising 20 vol % or more of hydrocarbons, reformable fuel, or a combination thereof by heat exchange with at least a portion of an anode effluent; reforming 15% or more of the hydrocarbons, reformable fuel, or a combination thereof, in the input flow to form a partially reformed input flow comprising 15 vol % or more of hydrocarbons, reformable fuel, or a combination thereof, an H₂ content of 15 vol % or more, and 5.0 vol % or more of carbon oxides; heating the partially reformed input flow to form an anode input flow comprising an anode input temperature of 550° C. or higher; passing the anode input flow into an anode of one or more molten carbonate fuel cells, an internal reforming element associated with the anode, or a combination thereof; passing a cathode input flow comprising 4.0 vol % or more of CO₂ and a cathode input temperature of 550° C. or higher into a cathode of the one or more molten carbonate fuel cells; operating the one or more molten carbonate fuel cells at an average current density of 100 mA/cm² or more and an operating voltage of 0.65 V to 0.75 V to form the anode effluent and a cathode effluent, the cathode effluent comprising a temperature that is greater than the cathode input temperature by 35° C. or more, the anode effluent comprising 18 vol % or more of H₂ and 10 vol % or less of hydrocarbons, reformable fuel, or a combination thereof.

Embodiment 2. The method of Embodiment 1, wherein the hydrocarbons, reformable fuel, or a combination thereof comprise at least one of methane and natural gas.

Embodiment 3. The method of any of the above embodiments, wherein the anode input flow comprises 0.5 vol % or more of CO, or wherein the anode input flow comprises 5.0 vol % or more of CO₂, or a combination thereof.

Embodiment 4. The method of any of the above embodiments, wherein the temperature of the cathode effluent is greater than the cathode input temperature by 50° C. or more.

Embodiment 5. The method of any of the above embodiments, wherein at least a portion of the reforming is performed during the heating of the input flow by heat exchange with the anode effluent; or wherein the heating of the partially reformed input flow is at least partially performed during the reforming of the input flow; or a combination thereof.

Embodiment 6. The method of any of the above embodiments, wherein the anode effluent comprises a temperature that is greater than the anode input temperature by 35° C. or more.

Embodiment 7. The method of any of the above embodiments, wherein the partially reformed input flow comprises 20 vol % or more of hydrocarbons, reformable fuel, or a combination thereof.

Embodiment 8. The method of any of the above embodiments, wherein the partially reformed input flow comprises 20 vol % or more of H₂; or wherein the anode effluent comprises 25 vol % or more of H₂; or a combination thereof.

Embodiment 10. The method of any of the above embodiments, further comprising heating a CO₂-containing flow in a heater to form the cathode input flow, wherein the heating the partially reformed input flow is performed in the heater, the method optionally further comprising pre-heating the CO₂-containing flow by heat exchange with at least a portion of the cathode effluent.

Embodiment 11. The method of any of the above embodiments, wherein the one or more molten carbonate fuel cells comprise a fuel cell stack.

Embodiment 12. The method of any of the above embodiments, wherein the one or more molten carbonate fuel cells are operated at a CO₂ utilization of 80% or more.

Embodiment 13. The method of any of the above embodiments, wherein the cathode input stream comprises 6.0 vol % or less of CO₂, or wherein the cathode effluent comprises 1.0 vol % or less of CO₂, or a combination thereof.

Embodiment 14. The method of any of Embodiments 1-13, wherein the cathode input stream comprises 4.0 vol % to 10 vol % of CO₂.

Embodiment 15. The method of any of the above embodiments, wherein the volume percentage of hydrocarbons, reformable fuel, or a combination thereof in the input flow is greater than the volume percentage of hydrocarbons, reformable fuel or a combination thereof in the anode effluent by 30 vol % or more.

Embodiment 16. A method for operating a molten carbonate fuel cell, comprising: heating an input flow comprising 20 vol % or more of hydrocarbons, reformable fuel, or a combination thereof by heat exchange with at least a portion of an anode effluent; reforming 15% or more of the hydrocarbons, reformable fuel, or a combination thereof, in the input flow to form a partially reformed input flow comprising 15 vol % or more of hydrocarbons, reformable fuel, or a combination thereof, an H₂ content of 15 vol % or more, and 5.0 vol % or more of carbon oxides; heating the partially reformed input flow to form an anode input flow comprising an anode input temperature of 550° C. or higher; passing the anode input flow into an anode of one or more molten carbonate fuel cells, an internal reforming element associated with the anode, or a combination thereof; passing a cathode input flow comprising 4.0 vol % or more of CO₂ and a cathode input temperature of 550° C. or higher into a cathode of the one or more molten carbonate fuel cells; operating the one or more molten carbonate fuel cells at an average current density of 100 mA/cm² or more, an operating voltage of 0.65 V to 0.75 V, and a fuel utilization of 30% or less to form the anode effluent and a cathode effluent, the cathode effluent comprising a temperature that is lower than the cathode input temperature, the anode effluent comprising 18 vol % or more of H₂ and 10 vol % or less of hydrocarbons, reformable fuel, or a combination thereof.

All numerical values within the detailed description and the claims herein are modified by “about” or “approximately” the indicated value, and take into account experimental error and variations that would be expected by a person having ordinary skill in the art.

Although the present invention has been described in terms of specific embodiments, it is not necessarily so limited. Suitable alterations/modifications for operation under specific conditions should be apparent to those skilled in the art. It is therefore intended that the following claims be interpreted as covering all such alterations/modifications that fall within the true spirit/scope of the invention.

What is claimed is:

1. A method for operating a molten carbonate fuel cell, comprising:
heating an input flow comprising 20 vol % or more of hydrocarbons, reformable fuel, or a combination thereof by heat exchange with at least a portion of an anode effluent;
reforming 15% or more of the hydrocarbons, reformable fuel, or a combination thereof, in the input flow to form a partially reformed input flow comprising 15 vol % or more of hydrocarbons, reformable fuel, or a combination thereof, an H₂ content of 15 vol % or more, and 5.0 vol % or more of carbon oxides;
heating the partially reformed input flow to form an anode input flow comprising an anode input temperature of 550° C. or higher;
passing the anode input flow into an anode of one or more molten carbonate fuel cells, an internal reforming element associated with the anode, or a combination thereof;
passing a cathode input flow comprising 4.0 vol % or more of CO₂ and a cathode input temperature of 550° C. or higher into a cathode of the one or more molten carbonate fuel cells;
operating the one or more molten carbonate fuel cells at an average current density of 100 mA/cm² or more and an operating voltage of 0.65 V to 0.75 V to form the anode effluent and a cathode effluent, the cathode effluent comprising a temperature that is greater than the cathode input temperature by 35° C. or more, the anode effluent comprising 18 vol % or more of H₂ and 10 vol % or less of hydrocarbons, reformable fuel, or a combination thereof.

2. The method of claim 1, wherein the hydrocarbons, reformable fuel, or a combination thereof comprise at least one of methane and natural gas.

3. The method of claim 1, wherein the anode input flow comprises 0.5 vol % or more of CO, or wherein the anode input flow comprises 5.0 vol % or more of CO₂, or a combination thereof.

4. The method of claim 1, wherein the temperature of the cathode effluent is greater than the cathode input temperature by 50° C. or more.

5. The method of claim 1, wherein at least a portion of the reforming is performed during the heating of the input flow by heat exchange with the anode effluent.

6. The method of claim 1, wherein the heating of the partially reformed input flow is at least partially performed during the reforming of the input flow.

7. The method of claim 1, wherein the anode effluent comprises a temperature that is greater than the anode input temperature by 35° C. or more.

8. The method of claim 1, wherein the partially reformed input flow comprises 20 vol % or more of hydrocarbons, reformable fuel, or a combination thereof.

9. The method of claim 1, wherein the partially reformed input flow comprises 20 vol % or more of H₂.

10. The method of claim 1, wherein the anode effluent comprises 25 vol % or more of H₂.

11. The method of claim 1, further comprising heating a CO₂-containing flow in a heater to form the cathode input flow, wherein the heating the partially reformed input flow is performed in the heater.

12. The method of claim 11, further comprising pre-heating the CO₂-containing flow by heat exchange with at least a portion of the cathode effluent.

13. The method of claim 1, wherein the one or more molten carbonate fuel cells comprise a fuel cell stack.

14. The method of claim 1, wherein the one or more molten carbonate fuel cells are operated at a CO₂ utilization of 80% or more.

15. The method of claim 1, wherein the cathode input stream comprises 6.0 vol % or less of CO₂, or wherein the cathode effluent comprises 1.0 vol % or less of CO₂, or a combination thereof.

16. The method of claim 1, wherein the cathode input stream comprises 4.0 vol % to 10 vol % of CO₂.

17. The method of claim 1, wherein the volume percentage of hydrocarbons, reformable fuel, or a combination thereof in the input flow is greater than the volume percentage of hydrocarbons, reformable fuel or a combination thereof in the anode effluent by 30 vol % or more.

18. A method for operating a molten carbonate fuel cell, comprising:
heating an input flow comprising 20 vol % or more of hydrocarbons, reformable fuel, or a combination thereof by heat exchange with at least a portion of an anode effluent;
reforming 15% or more of the hydrocarbons, reformable fuel, or a combination thereof, in the input flow to form a partially reformed input flow comprising 15 vol % or more of hydrocarbons, reformable fuel, or a combination thereof, an H₂ content of 15 vol % or more, and 5.0 vol % or more of carbon oxides;
heating the partially reformed input flow to form an anode input flow comprising an anode input temperature of 550° C. or higher;
passing the anode input flow into an anode of one or more molten carbonate fuel cells, an internal reforming element associated with the anode, or a combination thereof;
passing a cathode input flow comprising 4.0 vol % or more of CO₂ and a cathode input temperature of 550° C. or higher into a cathode of the one or more molten carbonate fuel cells;
operating the one or more molten carbonate fuel cells at an average current density of 100 mA/cm² or more, an operating voltage of 0.65 V to 0.75 V, and a fuel utilization of 30% or less to form the anode effluent and a cathode effluent, the cathode effluent comprising a temperature that is lower than the cathode input temperature, the anode effluent comprising 18 vol % or more of H₂ and 10 vol % or less of hydrocarbons, reformable fuel, or a combination thereof.
